(19) United States
(12) Patent Application Publication
(10) Pub. No.: US 2009/0249129 A1
(43) Pub. Date: Oct. 1, 2009

(54) Systems and Methods for Managing Multi-Component Systems in an Infrastructure

(76) Inventor: David Femia, Groton, MA (US)

Correspondence Address: K&L Gates LLP, STATE STREET FINANCIAL CENTER, One Lincoln Street, BOSTON, MA, 02111-2950, US

(21) Appl. No.: 12/241,723

(22) Filed: Sep. 30, 2008

Related U.S. Application Data
(60) Provisional application No. 60/998,837, filed on Oct. 12, 2007.

(51) Int. Cl. G06F 11/34; G06N 5/02

(52) U.S. Cl. 714/47; 706/47; 706/46; 714/E11.2

(57) ABSTRACT

The present invention discloses systems and methods to maintain a multi-component system. The methods include defining a performance factor to be maintained in a given system, and collecting by agents associated with a given container in the system data associated with the performance factor. The collected data is then used to generate a statistical model that describes the normal operating condition of a given system corresponding to the desired performance factor to be monitored. The method also includes collecting real time data corresponding to the desired performance factor, and finding deviations between the real time data and parameters in the statistical model in a given time range. If a deviation is found, an alert is sent to the user to notify the user of such a deviation. The method may further include a rules engine that launches a series of workflow steps after the user alert is triggered to provide mitigating steps for the users to perform to reduce any problem in the system before such deviation causes failure of the system.

### RELATED APPLICATIONS

This application claims priority to U.S. Provisional Patent Application 60/998,837 filed on Oct. 12, 2007, the disclosure of which is herein incorporated by reference in its entirety.

### FIELD OF THE INVENTION

The present invention relates to systems and methods for monitoring multi-component systems. More particularly, the invention relates to systems and methods for proactive real-time management of complex networks and infrastructures.

### BACKGROUND

For many Information Technology (IT) applications, such as for example online library catalog, gaming, internet social directory, or instant messaging, network users expect some reasonable level of computer availability. Some downtime in such network application is expected. Very few home users expect or require their IT network to be fully operationally at all times because neither the user's needs nor the data or applications in question relate to critical services or transactions. Conversely, if an IT network is the backbone for core business processes, market interactions or critical missions such as nuclear reactor operation, banking and credit transactions or medical record keeping, then continual availability is a requirement and not just a performance aspiration.

Complex IT systems routinely achieve above 99% uptime. These systems minimize downtime through quick recovery but are not designed to enable uninterrupted operations. Conversely, to achieve more than 99% uptime in a given lifecycle, unscheduled downtime approximately translates to between 45 minutes to 3.5 hours per month. Although unscheduled downtime is short and transient in nature, availability in such systems is crucial, especially for mission-critical systems and applications. Since any interruption in IT services, such as unscheduled downtime, affects business continuity and results in significant costs to businesses, it is necessary to have a subsystem to monitor application performance to reduce unnecessary downtime and to achieve continuous availability.

Continuous processing is one option for realizing continuous availability in a complex IT system. Continuous processing involves detection of anomalies in key components and/or key applications in the system during the operation of the system. If an anomalous condition or trend in a component and/or application is detected locally, a notification can be sent to circumvent the component and/or application without bringing down the entire system.

Despite the existence of monitoring systems, improved systems and methods for continual monitoring key components and/or key applications in a complex network system are still needed.

In particular, a need exists for improved methods and systems that use heuristics to analyze data generated and collected by the system to predict occurrence of anomalies in the future. Further, a need exists to monitor and trigger configurable workflow sequences in response to an anomaly in real time. Finally, there is a need for an architecture to enable a comprehensive solution, integrating with existing IT management tools and third party availability technologies.

The present invention addresses this need.

### SUMMARY OF THE INVENTION

The present invention relates to systems and methods for monitoring and maintaining a multi-component complex system by predicting an event of interest in the system using heuristics, and generating and maintaining one or more workflow sequences in response to such an event of interest.

In one aspect of the invention, a method of predicting an event of interest in a system having a plurality of components is disclosed. The method includes the steps of collecting data about a first component of the system; generating a model of the system in response to the collected data, in which the model has multiple parameters and each parameter has a predetermined value; defining an event in response to the model; collecting real time data about the system; and notifying that an event will occur when real time data acquired about the system changes relative to a predetermined value of a parameter in the model.

In one embodiment, the model is a statistical model generated in response to historic data. In another embodiment, the predetermined value is one of a number of thresholds and the parameter is one of a number of critical performance factors. The first component may be associated with a first agent which collecting the real time data. In a further embodiment, the first component is a container which includes at least one server. The method may further include the steps of informing at least one user of the potential occurrence of the event and providing a sequence of workflow steps to mitigate the event. In another embodiment, the method may include generating a sequence of workflow steps using a rules engine and at least one rule, the workflow steps selected to substantially keep the system in a normal operational state.

Another aspect of the invention discloses a method of maintaining a system having a plurality of components. The method includes the steps of selecting one performance factor associated with the system; selecting a time period associated with the one performance factor, such that the time period spanning at least operational cycle of the system; identifying two relative extrema that bound changes in the one performance factor; generating a number of sub-ranges of the performance factor using the time period and the two relative extrema; generating a model of the system in response to historic behavior of the system during each sub-range; acquiring real time data about the system; and notifying that an event of interest will occur when real time data acquired about the system signals a deviation from the historic behavior of the system during one of the number of sub-ranges.

In one embodiment, the model is a statistical model generated in response to historic data. In another embodiment, at least one component is associated with a first agent that collects real time data. In a further embodiment, at least one component is a container that includes at least one server. In yet another embodiment, the method includes the step of informing at least one user of the potential occurrence of the event by providing a sequence of workflow steps to mitigate the event and maintain substantially continuous availability for the system. The method may further include generating a sequence of workflow steps using a rules engine and at least one rule, in which, the workflow steps selected to substantially maintain the system at a normal operational state.

In yet another aspect of the invention, a monitoring subsystem adapted to maintain a system having multiple components is presented. The monitoring subsystem includes a number of data collecting agents adapted to transmit information, a memory element adapted to track changes in historical information and a processing unit adapted to receive information from agents. Each agent is associated with one or more components of the system, and is adapted to collect real time data associated with the system. The real time data include a plurality of datum, in which each datum having a range and a sub-range. The memory element adapted to track changes in historic information is associated with sub-ranges of data, such that the sub-ranges of data correspond to different operational states of the system. The processing unit adapted to receive the information from a number of agents, and is further adapted to generate alerts in response to deviations in one or more sub-ranges of data as a forecast of a failure in one or more components of the system.

The foregoing, and other features and advantages of the invention, as well as the invention itself, will be more fully understood from the description, drawings, and claims which follow. It should be understood that the terms “a,” “an,” and “the” mean “one or more,” unless expressly specified otherwise.

### BRIEF DESCRIPTION OF THE DRAWINGS

The foregoing and other objects, aspects, features, and advantages of the invention will become more apparent and may be better understood by referring to the following description taken in conjunction with the accompanying drawings, in which:

FIG. 1 is a diagram illustrating a multi-component system representing the interdependencies between different components and/or subsystems;

FIG. 2A is a flowchart illustrating an exemplary method for managing a continuously available monitoring subsystem; and

FIG. 2B is a diagram illustrating a multi-component system and data ranges associated with its operation for managing a continuously available monitoring subsystem.

### DETAILED DESCRIPTION

The following description refers to the accompanying drawings that illustrate certain embodiments of the present invention. Other embodiments are possible and modifications may be made to the embodiments without departing from the spirit and scope of the invention. Therefore, the following detailed description is not meant to limit the present invention. Rather, the scope of the present invention is defined by the appended claims.

It should be understood that the order of the steps of the methods of the invention is immaterial so long as the invention remains operable. Moreover, two or more steps may be conducted simultaneously or in a different order than recited herein unless otherwise specified.

The claimed invention provides methods and systems for monitoring and maintaining the operation of a multi-component system incorporating one or more computational elements, such as two servers, for example. In part, aspects of the claimed invention regulate components of the computer network system by detecting deviations from the norm in the operating performance of a network element. Network elements can include, but are not limited to servers, processors, applications, threads, databases, storage elements, and others.

The deviations associated with the operation of particular network element or group of network elements typically correspond to fluctuations resulting from hardware errors. When these fluctuations exceed or fall below a predetermined or user-specified triggering range, an alert is generated. This alert can be processed automatically or manually. In one embodiment, alerts are typically transmitted to different entities such as a system user.

Early detection of server and processor errors is another feature of the invention. These features are valuable since early detection of system problems reduces the likelihood of error propagation, system downtime, and electro-mechanical damage. In turn, limiting error propagation reduces overall system downtime which results in financial savings. Additionally, the systems and methods disclosed herein provide tools for quickly and accurately remedying these errors.

In addition, techniques for diagnosing system errors are further features of the invention. The diagnostic aspects of the invention offer recovery solutions to the user to regulate and correct the errors in the individual components in the servers or processors before the error propagates. By pinpointing the source of an error and the reason it started, future failures and downtime are avoided.

Aspects of the present invention relates to systems and methods for monitoring continuously available computing systems. One aspect of the invention relates to a method for predicting and maintaining events of interest in real time using mathematical heuristics. Another aspect of the present invention relates to methods for executing workflows in response to the detection of an event of interest. Moreover, another aspect of the present invention also relates to systems and methods for processing and analyzing parameters using real-time rule-based engines.

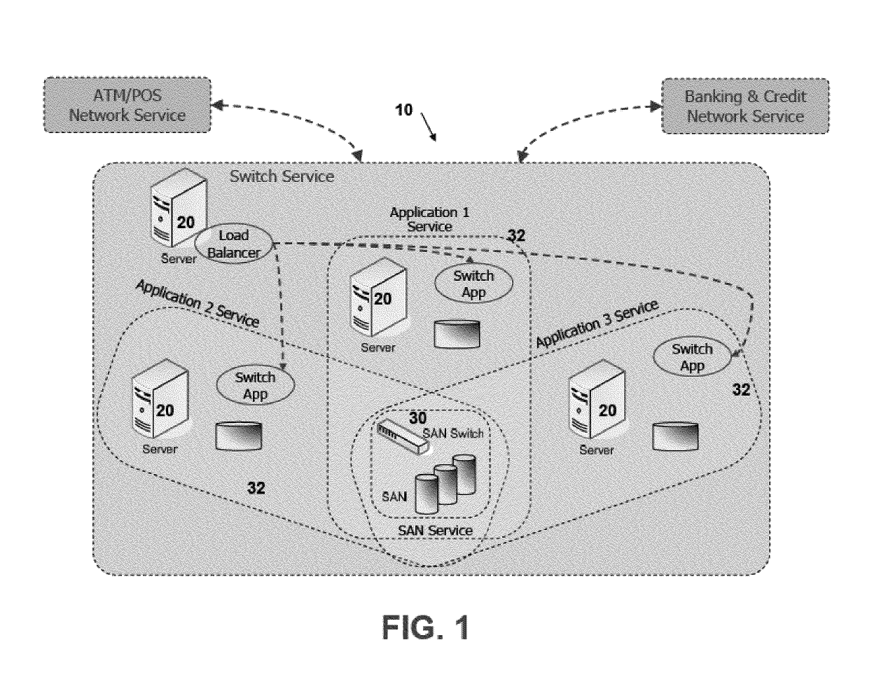

FIG. 1 depicts a multi-component network system 10 such as an IT infrastructure or an enterprise network. In one example, such a system 10 can support the continuous availability of mission critical systems. The maintenance of complex networks or infrastructure is crucial in providing reliable services, especially for high performance enterprise storage operations or complex IT networks.

Examples where such a network is used, include financial services (such as in the ATM/POS network, banking network, or credit card network), health care services (such as patient data management), telecommunications networks, securities, public safety, manufacturing and government services. Reactive management of such complex networks through routine maintenance and monitoring often leads to collapse of the system. This occurs because the only indication of a system failure occurs when an actual fault is detected. Such a failure or error event results in unscheduled downtime, and causes users of the complex network (such as an IT network or a financial network) not to be able to access stored information. The downtime translates to significant financial loss to companies relying on the complex network or infrastructure. It is desirable to have such systems and networks continuously available with no downtime. To achieve continuous availability, proactive management is needed to identify trouble spots and eliminate them before they cause any problems.

One embodiment of the invention relates to a method of predicting an event of interest in a system having a plurality of components. A financial network is an example of such a complex multi-component network. Financial institutions provide ATM/POS, banking and credit card network services, and require the continuous availability of their IT infrastructure to support their services globally. Customers access ATM or POS or use their credit cards at all hours. If the IT infrastructure of a bank encounters a failure in one of its servers or a problem in an application, operation of the overall network will be severely delayed. Regardless of how short the downtime is, a number of customers who attempt to access the network will not be able to do so. Such downtime causes the financial institution not only loss of transactions fees but loss of customer loyalty, which leads to loss of business.

FIG. 1 is a block diagram depicting a multi-component system (CAS) 10 suitable for providing services to an entity. As illustrated, the complex network is a multi-component system that has a storage area network (SAN) architecture, including a number of heterogeneous servers 20, connected to a single storage space by a SAN switch 30. A switched fabric having subnets 32 supports redundant paths between multiple servers 20, forming the network 10. As shown three subnets 32 having different associated subnet components are shown. Additional fabric switches 30 can be added to include more servers 20 in the network 10. As such, the techniques described herein with respect to servers and processors can also apply to processing subsystems that may contain processors, as well as boards, blades and modules. In general, the aspects of the invention are extendible to any system of computational elements that is suitable for error detection and diagnosis using a model-based approach.

As illustrated, CAS 10 preferably includes a number of subcomponents. It contains a plurality of containers and agents. In general a container is a computer representative element that includes another element. Thus, an element that references or links to an agent or includes other elements that link to an agent can be a container. In another embodiment, some containers are a software program or data element that holds and/or executes a set of commands. Thus, a container can control, include, run, and/or interact with other software routines in one embodiment.

As shown here, a container includes at least one software application in the SAN fabric. That is, each subnet 32 and its constituent overlapping and non-overlapping components can form a type of container. This container approach allows for a graphic user interface representation of container objects as icons. Each nested element in the container can be expanded in a branching manner in some graphic user interface embodiments.

Typically containers are grouped by services that support a particular function in the infrastructure. Containers and their elements can be associated with one or more agents. An agent may collect and monitor incoming data, and it may alert a user when a specific transaction occurs. Each container may have one or more agents, in which, each agent is a software routine that waits in the background and performs an action when a specified event occurs. Each agent can be associated with the particular data source. Key metrics from the service containers are collected by agents in real time to generate data.

Prior to discussing the system 10 in more detail, it is informative to consider the subsystem's general objective; maintaining continuous availability or extremely high availability. During normal operation, servers connect to other servers to run applications, transfer data or communicate with other servers throughout a complex network. Ideally, each server processes data at the same transaction speed during a computation. However, sometimes an error occurs in one server and delays the transaction processing speed of other servers in the network. These localized transient errors, if left undetected and uncorrected, may propagate to result in errors associated with server software or hardware failures. When small transient errors are detected, workflow procedures can be initiated to address the transient errors rather than the slower and reactive approach associated with restoring a server after it fails to transfer or process data from other servers. Thus, if the reactive and slower approach is used each time a server fails, uptime of a complex network is needlessly reduced.

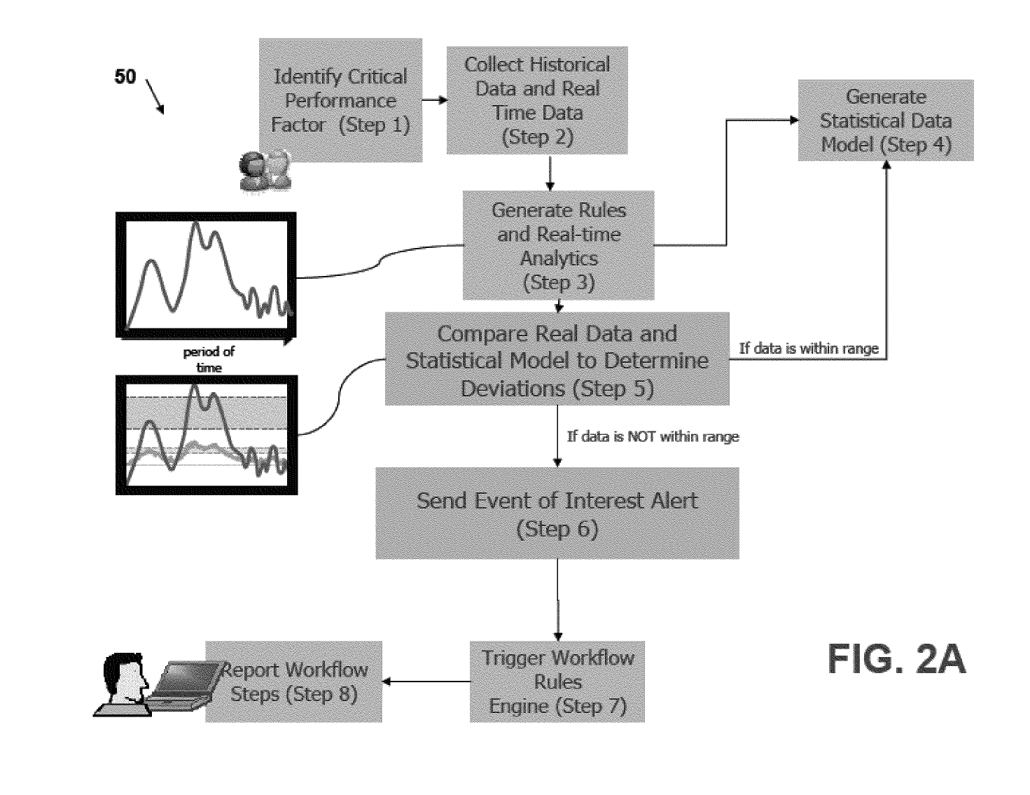

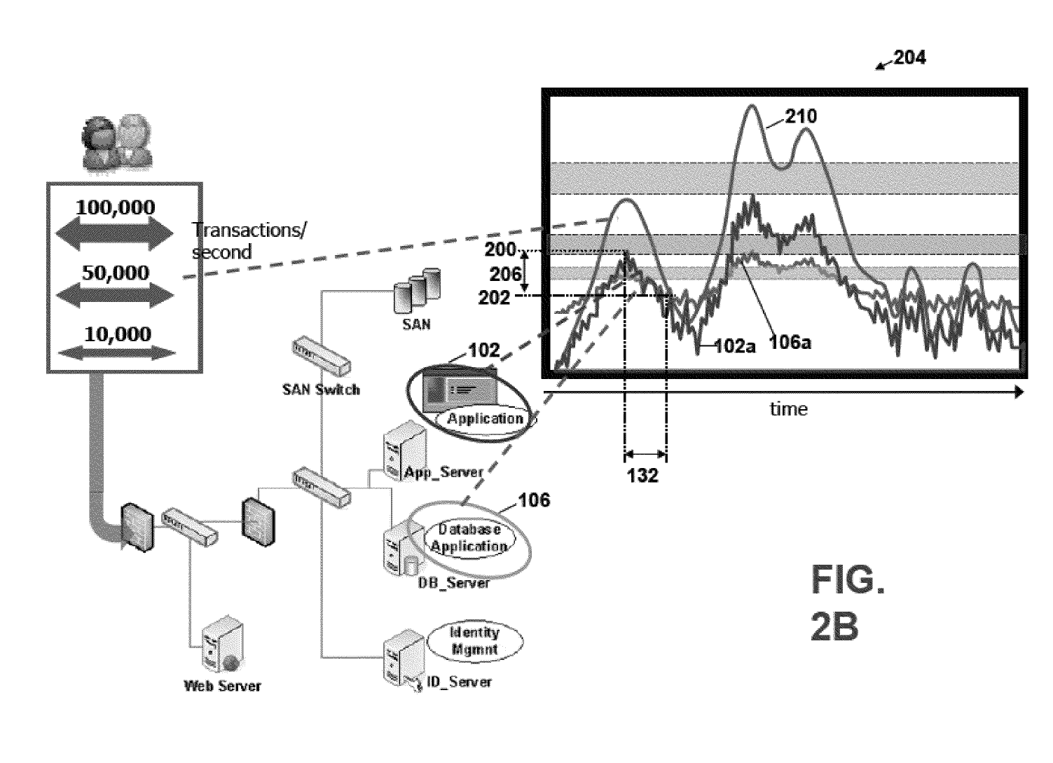

FIGS. 2A and 2B depict the processes involved to proactively manage a complex network system, such as system 10. In general, the methods disclosed herein include a triggering notification associated with an event. In one embodiment, triggering occurs by comparing real time collected data to historical data that has been processed using a model, and generating a statistical model from data collected in the system. As depicted, the proactive management method 50 represents different steps that occur in response to certain events. These processes can be implemented in hardware, software, firmware and combinations thereof. Various software implementations can be designed to run within the operating system environments running on the servers used in a given continuously available or highly available complex network or system.

As shown in FIG. 2A, the exemplary method 50 compares real-time collected data to a statistical model generated from historical data to trigger notification of an event, such a fault, slow down, status change, or other event of interest. Comparing real time data with historical data facilitates predicting events, in a prospective manner. Further, the comparison based approach helps prevent system failure from occurring by monitoring slight deviations in operating conditions that occur as a system component begins to fail.

First of all, a critical performance factor that may lead to system failure or any fault in the system has to be identified in (Step 1). In one embodiment, a performance factor is a key metric or a particular feature in a system that requires or is suitable for monitoring. Historical data regarding the desired performance factor is collected (Step 2) from the system component, and is then processed (Step 3) using statistical heuristics to generate (Step 4) a reliable mathematically based model to describe the normal working conditions of the system based on the critical performance factors. Real time data is then collected (Step 5) and is compared to the mathematical model to determine any deviation between the real time data and the historical data. Such a deviation is interpreted as an event of interest, which triggers an alert (Step 6). In turn, this alert can be sent to a user, such an IT manager, to take the steps necessary to maintain the system before such a deviation event propagates and leads a system fault. In a further embodiment, after sending an alert, a workflow rules engine is triggered (Step 7), and workflow steps are then reported (Step 8) to users.

As illustrated in FIG. 2B, in more detail, a multi-component system includes a plurality of containers. The agents collect data 102a and 106a from the applications 102, 106. In some embodiments, the agents collect data from a container associated with the two applications 102, 106. The data collected and other data (such as deviation data) is shown in the transaction graph 204.

Typically service containers are grouped by the services that support a particular function in the infrastructure. Key metrics from the service containers are collected by agents in real time to generate data as shown in the graph 204. The collected data is then transferred to a data storage system and stored as historical data 102a which is used to generate a model for determining deviations from historic data.

Mathematical heuristics and statistics are used to process the historical data 102a to generate a model of the system. Different heuristics and statistical rules of specific trending, thresholds or statistical process control rules such as Bayesian statistics, linear or nonlinear modeling or other techniques may be used to fit historical data 102a to the model. Such a model includes a plurality of parameters such that each parameter has a predetermined value. Each parameter is a user-specified critical performance factor that describes an operating condition of the system. For example, to measure the performance of a database, the capacity of the database memory cache can be monitored. The database memory cache capacity in this embodiment is a user-specified critical performance factor. The cache level data is then collected by an agent to generate a statistical model. Monitoring changes in transactions and data, such as cache reads and writes over time, allow error events to be predicted and corrected using the techniques disclosed herein.

A user then defines an event in response to the model to be monitored. For example, for an infrastructure or an environment with 10,000 to 100,000 transactions per seconds, the response time should be kept at less than five seconds to ensure continuous availability of the system. In the database memory cache for example, an event can be an occurrence in which the cache memory exceeds a user-specified level or threshold. However, these response times can vary and must be tailored to a given system implementation.

FIG. 2B is a flow diagram describing the generation of the statistical model and the comparison between the real time data and the statistical model. The performance of each supporting infrastructure component has a statistical relationship with the performance factor. Modeling and searching for deviation, such that the deviation state of curve 210, in real time in the infrastructure performance provides a “predictive” and proactive model in maintaining the system in good standing. Because a typical multi-component IT network or infrastructure performs many transactions per second (for example, a range between 10,000 and 100,000 transactions per second), a specific time period should be used to measure designed capability of an infrastructure. Generally, a time period 132 is at least one operating cycle of the system 10. However, the time period for measurement can be more or less. In some embodiments, initial time periods are used for components of the system. This allows data to be collected on a component-by-component basis and aggregated to yield a master set of system data. Both component data and master system data can be evaluated relative to historic data to predict deviations.

As shown in FIG. 2B, even though there is a statistical relationship between the performance factor in a given time parameter, the variance of the relationship may be so broad that it does not provide a reliable and continuous causal relationship as the basis for a comparison with real time data 106 to be collected. After identifying two relative extrema 200 and 202 in the performance factor in a plot against time, curve-fitting mathematical techniques may be used to “smooth” the variance. One technique is to average the relative extrema 200 and 202 in a given range to smooth out perturbations in the plot. However, if the time period 132 chosen in the calculation is too large, the statistical average taken in such a range may not represent the data set accurately. On the other hand, if a relatively small time period 132 is chosen, number of computations will increase significantly and may not be capable of being compared with real time data 106 within a given response time limit. In general, the range of a critical performance factor is divided into smaller increments 206 (bands). A plurality of relative extrema 200 and 202 corresponding to the smaller incremental value 206 and time period 132 are used to generate a mathematical model. In addition, a data plot shows a deviation curve 210. This curve 210 is generated using real time data of the system operating in abnormal condition such that the system exceeds the tolerable range.

After establishing a statistical model using historical data 102a, real time data 106a, and other master system or component data regarding a performance factor, real time data is then collected by the agent associated with the component. The system compares such data to the statistical model in real time. As illustrated in FIG. 2B, a plot of historical data 102a from agent 102, and real time data 106a from agent 106 are shown graphically. Because there are small variances in the real time data 106a for a given sub-range in time, no two sets of real time data 106a and parameters from the statistical model match exactly even if the system is operating normally in real time. A threshold amount of deviation may be specified by a user. If the discrepancy between the statistical model and real time data 106a exceeds the deviation threshold, an event of interest or a potential anomaly in the system may arise, and an alert is generated to prompt the user to mitigate such an anomaly before it arises to an actual fault in the system, which may potentially lead to system failure.

This real time proactive detection method warns users or maintenance personnel to deal with small anomalies in a subsystem as soon as possible. In the database memory cache example, after formulating a statistical model based on historical data of cache capacity as a parameter, and specifying a specific value as the threshold that the real time cache capacity data should not exceed, an agent collects real time cache capacity data, and submits the data to be compared to the statistical mode. If the database memory cache operates outside of its normal operating condition, the value of the real time cache capacity will exceed threshold capacity. A notification will alert users to such a potential anomaly. The threshold parameter can be set to be within a percentage of the normal operating condition based on historical data or to a specific-user level. A larger percentage yields a lower tolerance for anomaly, whereas a small percentage enables the system to be sensitive to small fluctuation in the operating conditions.

This embodiment further includes the step of informing at least one user of the potential occurrence of the event as illustrated in FIGS. 2A and 2B. A sequence of workflow steps, which is configurable, mitigates potential anomalies or events of interest, and recommends solutions or maintenance instructions for users to perform to prevent these events from escalating to system failure or malfunctions. These workflow steps may include IT Infrastructure Library (ITIL) based management tasks or other platform or system dependent management tasks. Moreover, the sequence of workflow steps may be generated to keep the system in a normal operational state. For example, ei3 Corporation provides a service platform that is a commercially available rules engine. Once a suspect parameter in a service container exceeds the threshold value of the model, mitigating workflow steps are automatically generated. These workflow steps are then displayed for users to follow to keep the system in a normal operational state. Third-party rules engines or tools such as WorkPoint by ACI Worldwide may also be incorporated in the system.

In the cache memory example, once the system detects that real time cache capacity exceeds a predetermined threshold value and triggers an event notification, the rules engine within the system will generate workflow steps to recommend to users. These workflow steps alert the user to reduce the existing cache demand or to configure a larger cache capacity before the application or database associated with the database cache memory crashes. This proactive monitoring system together with preventive workflow steps generation helps to maintain the infrastructure.

FIGS. 2A and 2B illustrate a further embodiment, in which a monitoring subsystem is adapted to maintain a multi-component system. The monitoring subsystem includes one or more agents that are used to collect data. As shown in FIG. 2B, two agents 102 and 106 are show as associated with a general application and a database application. This subsystem is layered above or adjacent to enterprise-side IT management tools such as OpenView, Tivoli or others. The subsystem may also be in one service container alone to collect and process data.

As described above, a complex network or infrastructure typically includes multiple components or containers. In this embodiment, each container has at least one server and application. To increase higher or continuous availability, each agent may be associated with one or more components in an infrastructure with redundant paths. Agents may collect and transmit real time data 106a to a subsystem to be processed. In some embodiments, the agents include a transceiver and a data monitoring functionality. Similar to the previous two embodiments, the real time data 106a collected has a series of relative extrema 200 and 202 corresponding to a series of sub-ranges 206.

This monitoring subsystem also includes a memory element that stores collected historical data 102a to be compared to real time data 106a. As shown in this example, these different data subsets are associated with agents 102, 106, respectively. The historical data 102a represent different operational states of the system within a given time period 132. Like real time data 106, historical data 102a also has multiple relative extrema 200 and 202 associated with sub-ranges 206.

After multiple agents transmit multiple data sets to a processing unit in the subsystem, a comparison between the collected real time data 106a and data generated from the statistical model based on historical data 102a in a given sub-range 206 is performed. Because the model generated from historical data 102a represents the normal operation of a system component, any deviation of the real time data 106a from the historical model signifies an anomaly in the system operation.

To prevent a system from failing, a user may specify a threshold level such that no deviation between the historical model and real time data 106 exceeds a given amount, for example, a threshold of 5%. If the deviation between collected real time data 106a and the historical model exceeds the threshold, a potential anomaly in the system may arise. In this proactive and event-driven system, an alert is generated to prompt the user to mitigate such a potential anomaly before it arises to an actual fault in the system, which may potentially lead to system failures.

A workflow generation system may be included in the system in response to sending a notification to users to forecast a potential failure of the system. As described in the previous embodiments, a workflow generation system may include ITIL processes or management tools to execute workflow steps to alert and provide users solutions to mitigate such a potential failure.

Variations, modification, and other implementations of what is described herein will occur to those of ordinary skill in the art without departing from the spirit and scope of the invention as claimed. Accordingly, the invention is to be defined not by the preceding illustrative description but instead by the spirit and scope of the following claims.

What is claimed is:

1. A method of predicting an event of interest in a system having a plurality of components, the method comprising the steps of:
collecting data about a first component of the system;
generating a model of the system in response to the collected data, the model comprising a plurality of parameters, each having a predetermined value;
defining an event in response to the model;
collecting real time data about the system; and
notifying that an event will occur when real time data acquired about the system changes relative to a predetermined value of a parameter in the model.

2. The method of claim 1 wherein the model is a statistical model generated in response to historic data.

3. The method of claim 1 wherein the predetermined value is one of a plurality of thresholds and the parameter is one of a plurality of critical performance factors.

4. The method of claim 1 wherein the first component is associated with a first agent, the first agent collecting the real time data.

5. The method of claim 1 wherein the first component is a container, wherein the container comprises at least one server.

6. The method of claim 1 further comprising the steps of informing at least one user of the potential occurrence of the event and providing a sequence of workflow steps to mitigate the event.

7. The method of claim 1 further comprising generating a sequence of workflow steps using a rules engine and at least one rule, the workflow steps selected to substantially keep the system in a normal operational state.

8. A method of maintaining a system having a plurality of components, the method comprising the steps of:
selecting one performance factor associated with the system;
selecting a time period associated with the one performance factor, the time period spanning at least operational cycle of the system;
identifying two relative extrema that bound changes in the one performance factor;
generating a plurality of sub-ranges of the performance factor using the time period and the two relative extrema;
generating a model of the system in response to historic behavior of the system during each of the plurality of sub-ranges;
acquiring real time data about the system; and
notifying that an event of interest will occur when real time data acquired about the system signals a deviation from the historic behavior of the system during one of the plurality of sub-ranges.

9. The method of claim 8 wherein the model is a statistical model generated in response to historic data.

10. The method of claim 8 wherein at least one component is associated with a first agent, the first agent collecting the real time data.

11. The method of claim 8 wherein at least one component is a container, wherein the container comprises at least one server.

12. The method of claim 8 further comprising the step of informing at least one user of the potential occurrence of the event by providing a sequence of workflow steps to mitigate the event and maintain substantially continuous availability for the system.

13. The method of claim 8 further comprising generating a sequence of workflow steps using a rules engine and at least one rule, the workflow steps selected to substantially maintain the system at a normal operational state.

14. A monitoring subsystem adapted to maintain a system having a plurality of components, the subsystem comprising:
a plurality of data collecting agents adapted to transmit information, each agent associated with one or more components of the system, the agents adapted to collect real time data associated with the system, the real time data comprising a plurality of datum, each datum having a range and a sub-range;
a memory element adapted to track changes in historic information associated with sub-ranges of data; the sub-ranges of data corresponding to different operational states of the system; and
a processing unit adapted to receive the information from the plurality of agents, the processing unit further adapted to generate alerts in response to deviations in one or more sub-ranges of data as a forecast of a failure in one or more components of the system.
